(19) United States
(12) Patent Application Publication
(10) Pub. No.: US 2002/0146235 A1
(43) Pub. Date: Oct. 10, 2002

(54) Method and apparatus for playing back and editing information

(75) Inventors: Kazutomo Watanabe, Tokorozawa-City (JP); Ichiro Miyake, Tokorozawa-City (JP); Tsutomu Takahashi, Tokorozawa-City (JP); Kenichiro Tada, Tokorozawa-City (JP); Yasuyuki Noda, Tokorozawa-City (JP); Gaku Yamamura, Tokorozawa-City (JP); Masayoshi Murayama, Fukuroi-shi (JP); Hiroshi Kida, Fukuroi-shi (JP); Tsutomu Ohtani, Fukuroi-shi (JP); Masaaki Saito, Fukuroi-shi (JP)

Correspondence Address: SUGHRUE MION, PLLC, 2100 Pennsylvania Avenue, NW, Washington, DC, 20037-3213, US

(73) Assignee: PIONEER CORPORATION,

(21) Appl. No.: 10/062,558

(22) Filed: Feb. 5, 2002

(30) Foreign Application Priority Data
Feb. 6, 2001 (JP) 2001-29036

(51) Int. Cl. H04N 5/92; G11B 27/00; G09G 5/00

(52) U.S. Cl. 386/52; 386/69; 345/723

(57) ABSTRACT

A hard disc recorder searches some pieces of information that match a search condition from a plurality of pieces of information recorded on a recording medium. The hard disc recorder then prepares playback order information to successively play the searched pieces of information in a desired order. A new name is assigned to the searched pieces of information on the basis of the search condition.

### BACKGROUND OF THE INVENTION

1. Field of the Invention

The present invention relates to an apparatus and method for editing pieces of information selected from a plurality of pieces of information recorded on a recording medium.

2. Description of the Related Art

In recent times, a hard disc recorder and a hard disc are often employed, instead of a video tape recorder and a video tape, to record a broadcast program such as a television program. When the hard disc recorder records a plurality of television programs on the hard disc, the hard disc recorder can edit the recorded programs. Specifically, a user of the hard disc recorder arbitrarily selects some of the recorded programs and combines (or rearranges) them to a new group of program. This is an editing function of the hard disc recorder.

In order to utilize the editing function, however, the user first has to select all the desired programs from a plurality of programs recorded on the hard disc. This selecting operation is troublesome.

### SUMMARY OF THE INVENTION

An object of the present invention is to provide an information playback/edit apparatus and method that allows a user to hypothetically create a new program made from desired pieces of information, which are selected from a plurality of pieces of information recorded on a recording medium with an easy operation.

According to one aspect of the present invention, there is provided an information playback/edit apparatus for reproducing at least one piece of information from a plurality of pieces of information recorded on a recording medium comprising, a unit for searching pieces of information that match a search condition from a plurality of pieces of information recorded on the recording medium, and a unit for preparing playback order information to successively play the searched pieces of information in predetermined order. When a user inputs the search condition, the apparatus finds out all the pieces of information that meet the search condition. The apparatus then automatically determines the playback order of these pieces of information in accordance with the user's preference. The searched pieces of information therefore creates a group of pieces of information rearranged in a desired manner so that they can be considered to be a new piece of information. Thus, the user can easily edit the recorded pieces of information or makes a hypothetical new piece of information.

The information playback/edit apparatus may further include a unit for creating name information representing the searched pieces of information on the basis of the search condition and a memory for storing the name information together with the playback order information.

Each piece of information may be image data representing a television program, and the search condition may be at least one of a name of the television program, a genre of the television program and a person's name (personal name) appearing in the television program.

According to a second aspect of the present invention, there is provided a method of editing some pieces of information which are selected from a plurality of pieces of information recorded on a recording medium comprising the steps of searching pieces of information that match a search condition from a plurality of pieces of information recorded on the recording medium, preparing playback order information to successively play the searched pieces of information in predetermined order, creating name information representing the searched pieces of information on the basis of the search condition, and storing the name information together with the playback order information.

### BRIEF DESCRIPTION OF THE DRAWINGS

FIG. 1 illustrates an inside structure of a hard disc recorder, which is an example of an information playback/edit apparatus according to the present invention;

FIG. 2 illustrates two memory regions defined on a hard disc shown in FIG. 1;

FIG. 3 illustrates a group of recorded program information and a group of edited program information, both recorded in a management region of the hard disc shown in FIG. 2;

FIG. 4 illustrates a control panel of an operation unit;

FIG. 5 illustrates a subroutine for edit control;

FIG. 6 illustrates an edit screen of a display unit;

FIG. 7 is similar to FIG. 6 and illustrates the edit screen of the display unit that indicates selected programs;

FIG. 8 is similar to FIG. 7 and illustrates the edit screen when the selected programs are rearranged in accordance with a desired playback order; and

FIG. 9 illustrates a screen of the display unit that shows a list of recorded programs.

### DETAILED DESCRIPTION OF THE INVENTION

Embodiments of the present invention will be described in reference to the accompanying drawings.

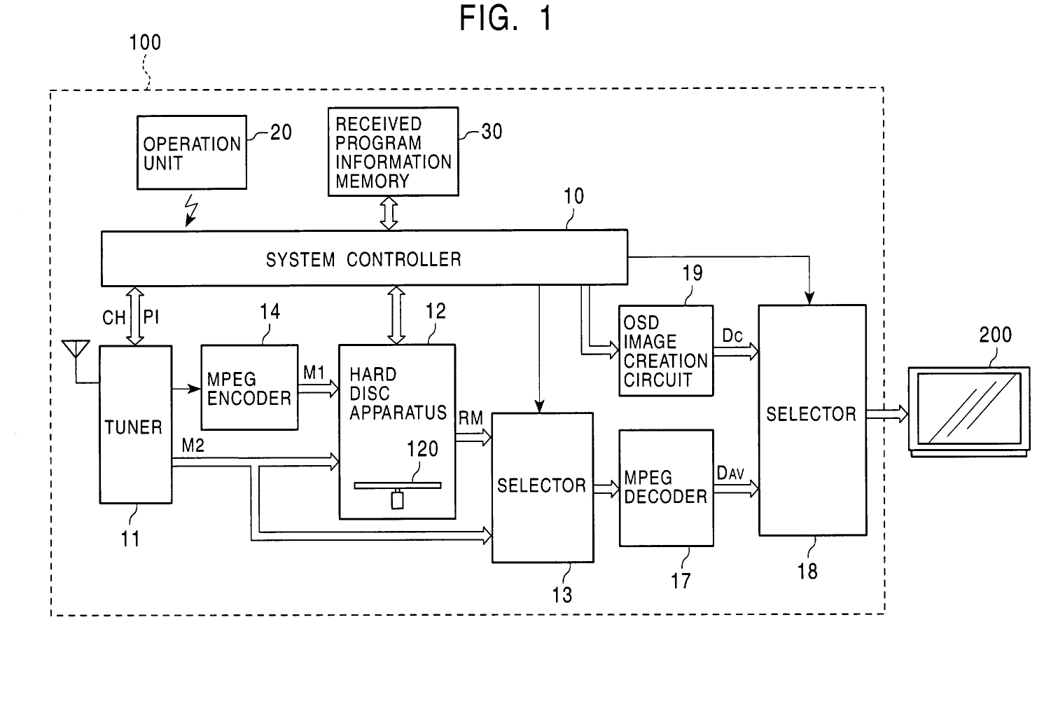

Referring first to FIG. 1, illustrated is a schematic block diagram of a hard disc recorder 100, which is an example of an information playback apparatus according to the present invention.

A tuner 11 receives an airwave (channel) designation signal CH from a system control circuit 10. The airwave designation signal CH is used to designate a certain airwave among a plurality of analog television airwaves (NTSC, PAL or SECAM). The tuner 11 then accepts the designated analog television airwave, and demodulates the analog television airwave signal to a television signal. The television signal is supplied to an MPEG encoder 14 from the tuner 11. The MPEG encoder 14 applies an MPEG (Moving Picture Experts Group) coding process to the television signal to obtain an MPEG signal M1. The MPEG encoder 14 then feeds the MPEG signal M1 to a hard disc apparatus 12. When the tuner 11 receives another airwave designation signal CH, which designates a certain digital airwave, from the system control circuit 10, the tuner 11 accepts a designated digital airwave. The tuner 11 demodulates the digital airwave signal to obtain another MPEG signal M2, and supplies the MPEG signal M2 to the hard disc apparatus 12 and a selector 13 respectively.

The tuner 11 also extracts electronic program guidance information from the received airwave. With this guidance information, the tuner 11 creates program information PI of the received television program and supplies the program information PI to the system control circuit 10. The program information PI represents, for example, a name of the television show, an airdate, time, genre, featured people (i.e., a personal name), a channel number, etc. The system control circuit 10 stores the program information PI into a received program information memory 30.

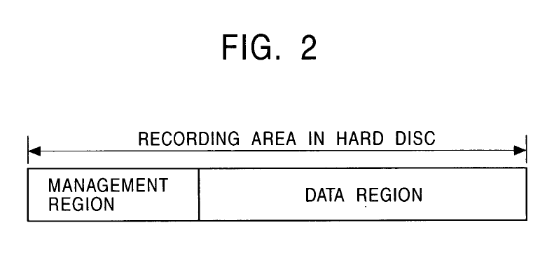

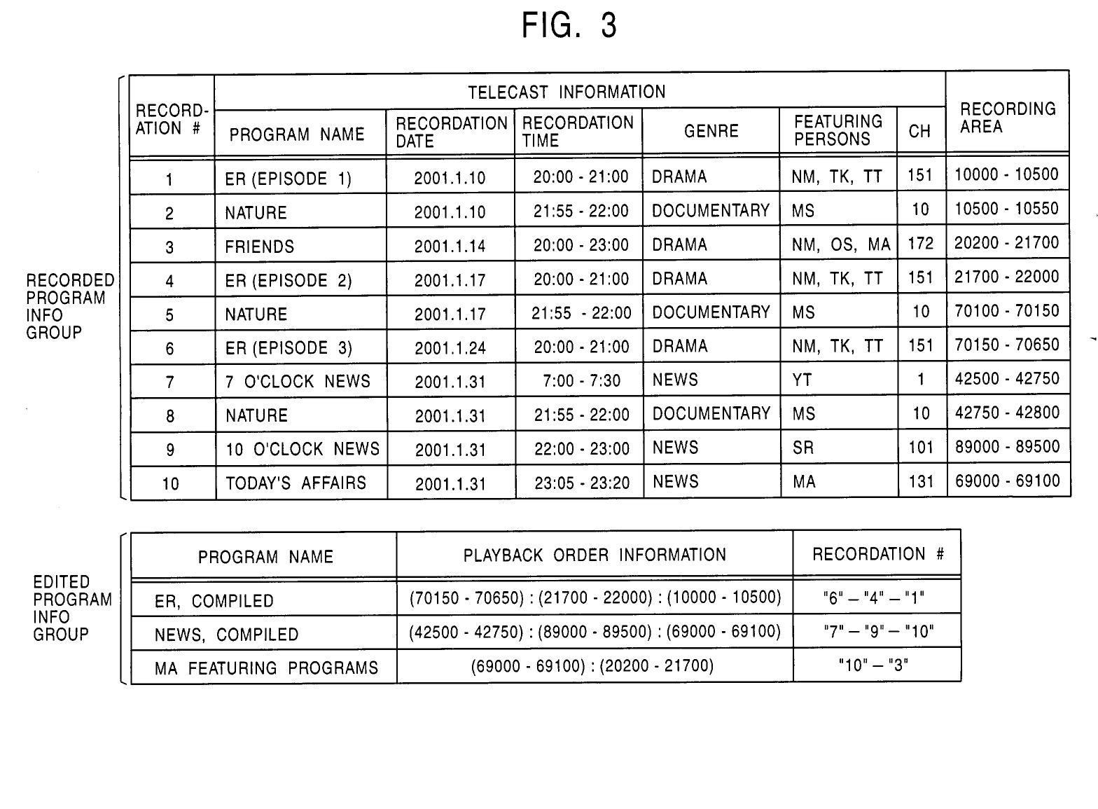

The hard disc apparatus 12 records a series of MPEG signals M1 or M2, which carry the received television program, in a data region of a hard disc 120 in response to a recordation command and the program information PI supplied from the system control circuit 10. Referring to FIG. 2, the hard disc 120 has a management region and the data region. When recordation of one television program is complete, the hard disc apparatus 12 additionally writes recorded program information as shown in FIG. 3 into the management region of the hard disc 120. The recorded program information includes recording area information, which represents an area inside the hard disc 120 used to record that program, and telecast information prepared from the program information PI. As seen in FIG. 3, the telecast information indicates the program name, recordation date, recordation time, genre, featured people and channel number.

The hard disc apparatus 12 retrieves the MPEG signals from the hard disc 120 in accordance with a playback command supplied from the system control circuit 10. The playback command designates a program to be played back. The hard disc apparatus 12 then supplies the retrieved MPEG signals RM to the selector 13. These MPEG signals are referred to as playback MPEG signals.

The selector 13 selects one of the two MPEG signals, either the playback MPEG signal RM supplied from the hard disc apparatus 12 or the MPEG signal M2 supplied from the tuner 11, in accordance with a selection signal issued from the system control circuit 10. The selector 13 supplies the selected MPEG signal to an MPEG decoder 17. The MPEG decoder 17 applies an MPEG decoding process to the MPEG signal to obtain an audio/video signal D_{AV}. The audio/video signal D_{AV} is introduced to a second selector 18. An OSD (On Screen Display) image creation circuit 19 creates an image signal D_{C}, which is used to display various messages and/or images in accordance with a command and data fed from the system control circuit 10. The image signal D_{C} is introduced to the second selector 18. The second selector 18 selects one of the audio/video signal D_{AV} and the image signal D_{C} in accordance with a second selection signal fed from the system control circuit 10. The selected signal is transferred to a display device 200. The display device 200 reproduces an image and/or sound on the basis of the audio/video signal D_{AV} or the image signal DC supplied from the hard disc recorder 100.

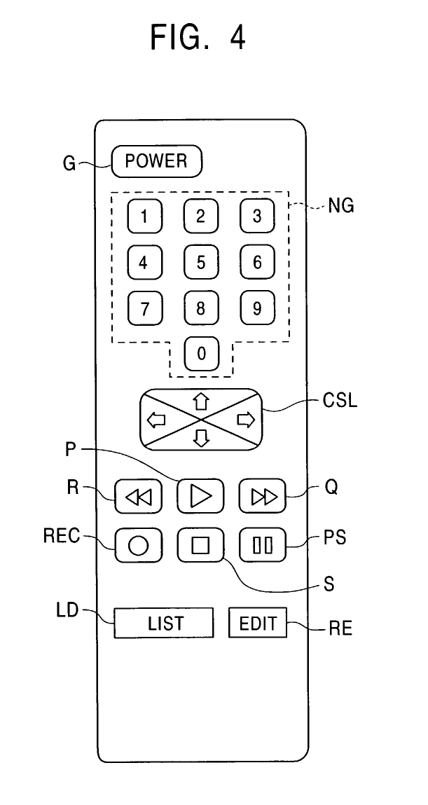

An operation unit 20 is, for example, a remote controller having a control panel as shown in FIG. 4. The control panel includes a power switch G for turning on and off the hard disc recorder 100, a group of numeric buttons NG for specifying a channel and/or entering numbers as well as characters, and a cursor button CSL for moving a selection box or frame (will be described) within a display screen of the display device 200. The control panel also includes a play button P for causing the hard disc recorder 100 to play back or reproduce a recorded image and/or sound (voice), a quick-forward button Q, a rewind button R, a pause button PS, a stop button S and a recordation button REC. The control panel further includes a list display button LD for displaying a list of all the programs recorded on the hard disc 120, and an edit button RE for displaying an edit screen.

The operation unit 20 is operated by a user and generates an operation signal corresponding to the button pressed by the user. The operation unit 20 transmits the operation signal to the system control circuit 10 by means of a short-distance radio interface such as infrared radiation or Bluetooth.

The system control circuit 10 receives the operation signal from the operation unit 20 and controls the hard disc recorder 100 in accordance with the operation signal.

Operations of the hard disc recorder 100 under the control of the system control circuit 10 will be described in detail. The operations include use of the display device 200 as a television monitor, recordation of broadcast programs, edition of the recorded programs, and reproduction of the recorded television programs.

(1) TV Monitor

When a user wants to watch a television show in realtime, the user first presses a certain button in the numeric button group NG on the remote controller 20 to specify a desired channel. The system control circuit 10 then feeds a channel designation signal CH, which represents the desired channel, to the tuner 11. At the same time, the system control circuit 10 supplies a selection signal to the first selector 13 such that the MPEG signal M2 supplied from the turner 11 is transferred to the MPEG decoder 17. In addition, the system control circuit 10 feeds another selection signal to the second selector 18 such that the audio/video signal DAV derived from the MPEG decoder 17 is transferred to the display device 200. As a result, the MPEG signal M2, which is received and demodulated by the tuner 11, is decoded to the audio/video signal D_{AV} by the PMEG decoder 17 and introduced to the display device 200. Accordingly, the display device 200 displays a digital television show of the desired channel in realtime.

(2) Recordation

If the user wants to record a television show received at the tuner 11, the user presses the recordation button REC on the remote controller 20 while the tuner 11 is receiving the television program. The system control circuit 10 then reads program information PI of the currently received program from the received program information memory 30. The system control circuit 10 supplies the program information PI and a program recordation command to the hard disc apparatus 12. Upon receiving the recordation command, the hard disc apparatus 12 records the MPEG signals supplied from the tuner 11 in a vacant area in the data region on the hard disc 120. When the single television program is entirely recorded, the hard disc apparatus 12 writes the recorded program information into the management region of the hard disc 120. The recorded program information includes, as mentioned earlier, the recording area information which indicates where of the hard disc 120 the program is recorded, and the telecast information derived from the program information PI.

When the recordation is performed using a timer function, the MPEG signals carrying the television program received at the tuner 11 are recorded in the data region of the hard disc 120. The recorded program information which includes the information about the recording area and the telecast information prepared from the program information PI is written into the management region of the hard disc 120 as shown in FIG. 3.

(3) Editing

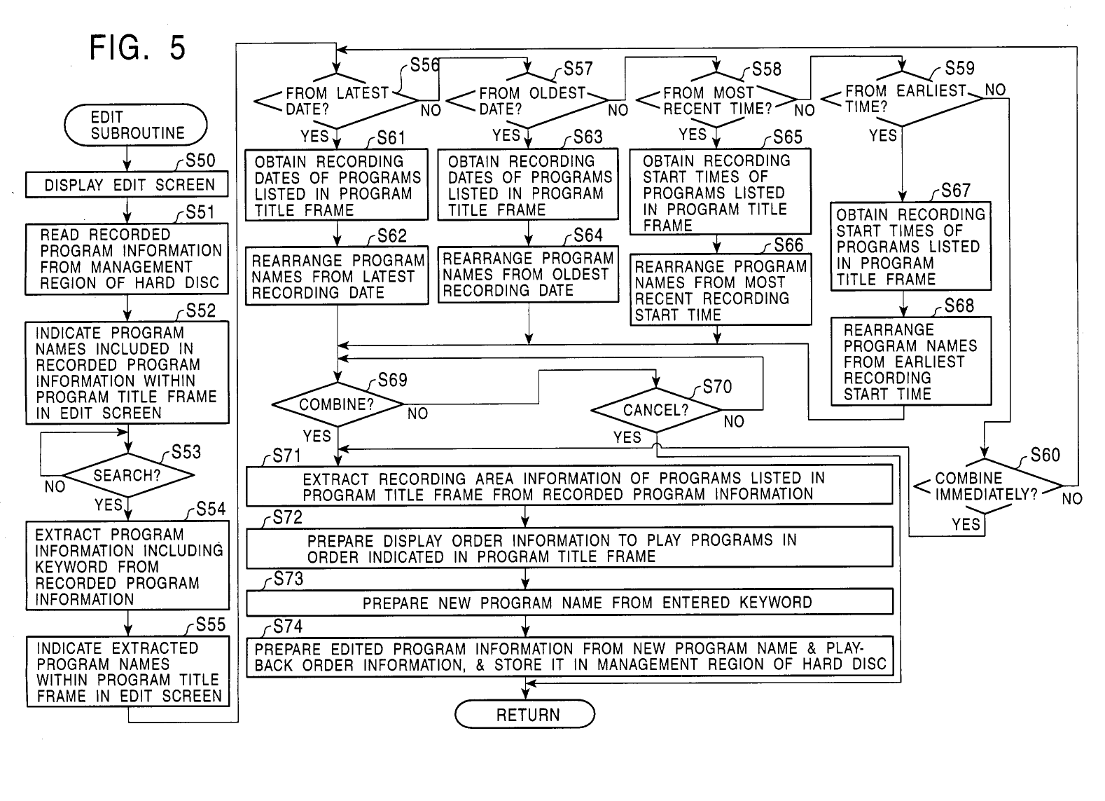

When a user wants to rearrange some of the recorded programs to a new group of programs, the user first presses the edit button RE on the remote controller 20. The control program of the system control circuit 10 then enters an edit subroutine as shown in FIG. 5.

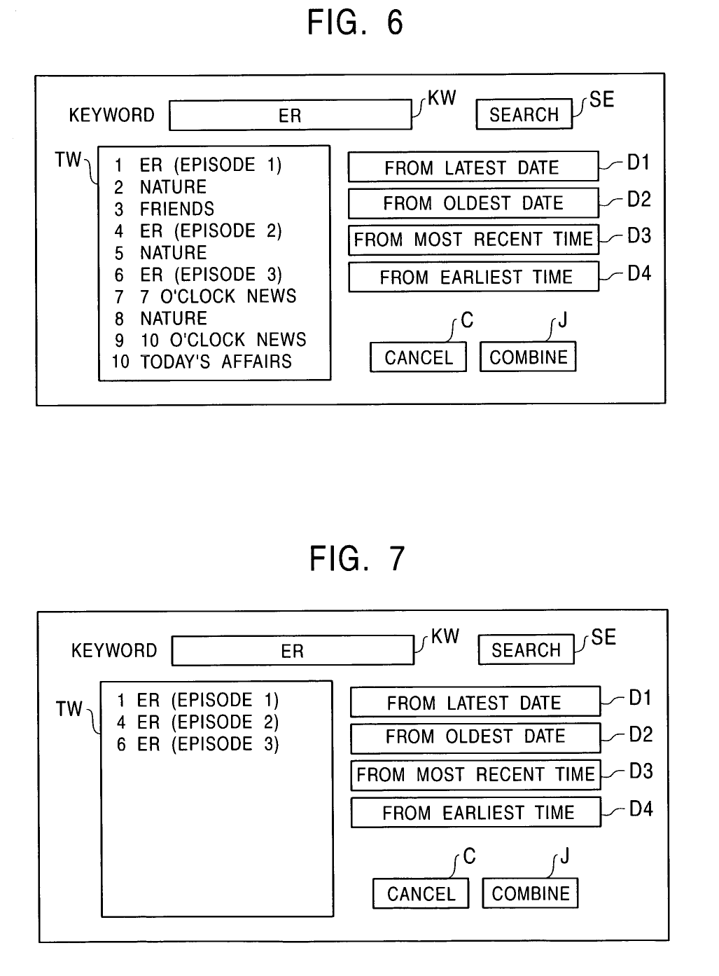

In FIG. 5, the system control circuit 10 issues an edit screen request to the OSD image creation circuit 19 such that an edit screen as shown in FIG. 6 is displayed on the display unit 200. The system control circuit 10 also issues a selection signal to the second selector 18 to allow an image signal D_{C} prepared by the OSD image creation circuit 19 to be passed to the display unit 200 (Step S50). The system control circuit 10 then issues a command to the hard disc apparatus 12 to read all the recorded program information stored in the management region of the hard disc 120 (Sep S51). Upon receiving this command, the hard disc apparatus 12 retrieves all the recorded program information of FIG. 3, which is stored in the management region of the hard disc 120, and supplies the recorded program information to the system control circuit 10. The system control circuit 10 accepts the recorded program information, and issues a command to the OSD image creation circuit 19 such that all the names of the programs included in the recorded program information are indicated inside a program title frame TW on the edit screen as shown in FIG. 6 (Step S52).

By executing Steps S50 to S52, therefore, the display unit 200 displays the edit screen as shown in FIG. 6, i.e., the screen in which all the names of the programs recorded on the hard disc 120 are listed within the program title frame TW.

Subsequently, the system control circuit 10 determines whether a search button SE shown on the edit screen is clicked or not. The subroutine program does not proceed further until the search button SE is clicked (Step S53).

The user operates the numeric button group NG on the remote controller 20 to enter a keyword of each of programs, which the user wants to pick up and rearrange, into a keyword entry section KW on the edit screen. The keyword is used to search the target program, and is considered to be a search condition. When the user wants to choose and rearrange a plurality of programs belonging to a certain genre among those recorded on the hard disc 120, the user enters a name of the genre into the keyword entry section KW. The genre name is, for instance, “news”, “drama”, “sports” or “documentary”. If a plurality of programs having the same program name should be collected, the user inputs the program name into the keyword entry section KW. If a plurality of programs in which a particular person appears should be collected, the user inputs his or her name into the keyword entry section KW.

After entering the keyword, the user operates the cursor button CSL on the remote controller 20 to click the search button SE shown on the edit screen.

Upon clicking of the search button SE, the system control circuit 10 extracts all program information which includes the keyword input into the keyword entry section KW, from the recorded program information obtained at Step S52 (Step S54). The system control circuit 10 issues a command to the OSD image creation circuit 19 such that all the program names in the program information extracted at Step S54 are listed within the program title frame TW on the edit screen as shown in FIG. 7 (Step S55).

As a result, when the program name “ER” is input to the keyword entry section KW and Steps S54 and S55 are executed, then the program names “ER (Episode 1)”, “ER (Episode 2)” and “ER (Episode 3)” are extracted from the recorded program information of FIG. 3. Consequently, the program names “ER (Episode 1)”, “ER (Episode 2)” and “ER (Episode 3)” are indicated in the program title frame TW on the edit screen as shown in FIG. 7.

When the genre “news” is input to the keyword entry section KW, all the programs of which genre is news are picked up from the recorded program information of FIG. 3. Specifically, “7 o'clock news”, “10 o'clock news” and “today's affairs” are extracted. These program names are indicated in the program title frame TW.

When a person's (personal) name “MA” is input to the keyword entry section KW, all the programs in which the person “MA” appears are picked up from the recorded program information of FIG. 3. Specifically, “Friends” and “today's affairs” are extracted. These program names are indicated in the program title frame TW.

Next, the user operates the cursor button CSL to click one of playback order buttons D1 to D4 shown on the edit screen in order to decide the order of reproducing the programs indicated in the program title frame TW. Specifically, if the user wishes to arrange the programs indicated in the program title frame TW from the latest date, the user presses the button D1. If the user wishes to arrange the programs in the opposite way (i.e., from the oldest date), the user presses the button D2. If the user wishes to arrange the programs from the most recent time, the user presses the button D3. If the user wishes to arrange the programs from the earliest time, the user presses the button D4. It should be noted that if the order of the programs first displayed in the program title frame TW can be used, the user operates the cursor button CSL to click a grouping button (rearrangement OK button) J shown on the edit screen.

In the meantime, the system control circuit 10 determines whether the playback order determination button D1 is clicked or not (Step S56). When the button D1 is not clicked at Step S56, the system control circuit 10 determines whether the second playback order determination button D2 is clicked or not (Step S57). When the second button D2 is not clicked at Step S57, the system control circuit 10 determines whether the third playback order determination button D3 is clicked or not (Step S58). When the third button D3 is not clicked at Step S58, the system control circuit 10 determines whether the fourth playback order determination button D4 is clicked or not (Step S59). When the fourth button D4 is not clicked at Step S59, the system control circuit 10 determines whether the rearrangement OK button J is clicked or not (Step S60). When the rearrangement OK button J is not clicked at Step S60, the subroutine program returns to Step S56 to repeat the above described determinations. In sum, the system control circuit 10 repeatedly makes the above described determinations until one of the buttons D1 to D4 and J is clicked.

When it is determined at Step S56 that the first playback order determination button D1 is clicked, the subroutine program proceeds to Step S61. Specifically, the system control circuit 10 extracts program information of the programs indicated in the program title frame TW of FIG. 7 from the recorded program information of FIG. 3 to obtain information about recording dates of these programs (Step S61). The system control circuit 10 issues a command to the OSD image creation circuit 19 to change the order of the programs indicated in the program title frame TW from the latest date on the basis of the recording date information (Step S62).

When it is determined at Step S57 that the second playback order determination button D2 is clicked, the subroutine program proceeds to Step S63. Specifically, the system control circuit 10 extracts program information of the programs indicated in the program title frame TW of FIG. 7 from the recorded program information of FIG. 3 to obtain information about recording dates of these programs (Step S63). The system control circuit 10 issues a command to the OSD image creation circuit 19 to change the order of the programs indicated in the program title frame TW from the oldest date on the basis of the recording date information (Step S64).

When it is determined at Step S58 that the third playback order determination button D3 is clicked, the subroutine program advances to Step S65. Specifically, the system control circuit 10 extracts program information about the programs indicated in the program title frame TW of FIG. 7 from the recorded program information of FIG. 3 to obtain information about recording time of these programs (particularly when the recording of each of the programs is started) (Step S65). The system control circuit 10 issues a command to the OSD image creation circuit 19 to change the order of the programs indicated in the program title frame TW from the most recent recordation start time on the basis of the recording time information (Step S66).

When it is determined at Step S59 that the fourth playback order determination button D4 is clicked, the subroutine program advances to Step S67. Specifically, the system control circuit 10 extracts program information about the programs indicated in the program title frame TW of FIG. 7 from the recorded program information of FIG. 3 to obtain information about recording time of the programs (Step S67). The system control circuit 10 issues a command to the OSD image creation circuit 19 to change the order of the programs indicated in the program title frame TW from the earliest recording start time on the basis of the recording time information (Step S68).

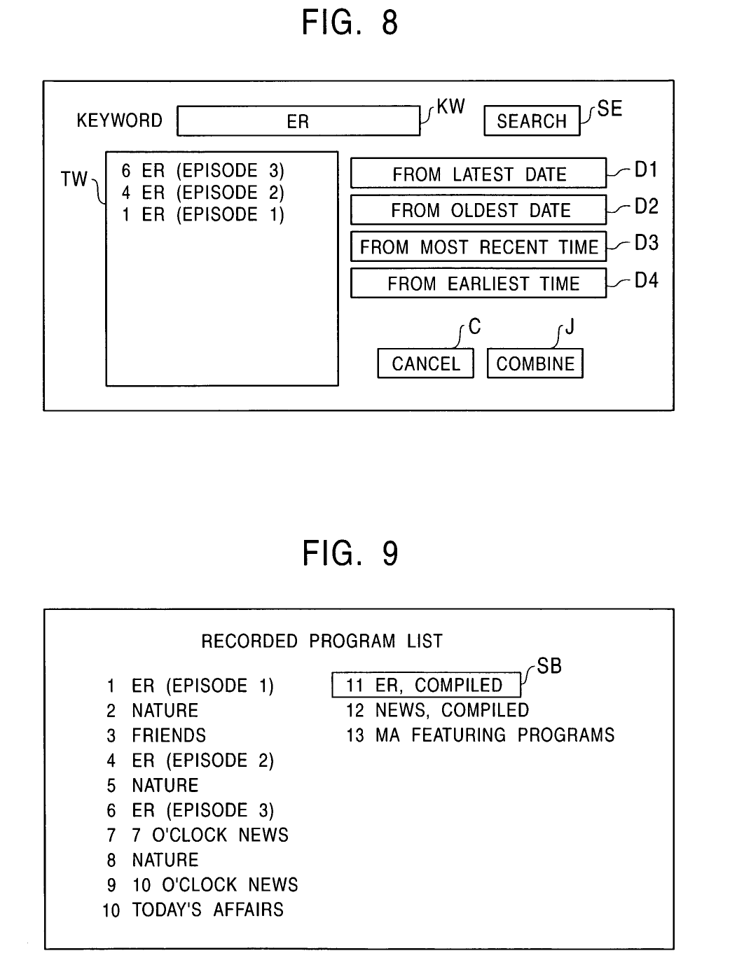

Accordingly, if the user clicks the first playback order determination button D1 present in the edit screen shown in FIG. 7, the programs in the program title frame TW are rearranged from the latest date as shown in FIG. 8. Specifically, the order of the program names “ER (Episode 1)”, “ER (Episode 2)” and “ER (Episode 3)” is changed to “ER (Episode 3)”, “ER (Episode 2)” and “ER (Episode 1)”. The user then clicks the rearrangement OK button J present in the edit screen with the cursor button CSL.

After Step S62, S64, S66 or S68 is executed, the system control circuit 10 determines whether the rearrangement button J is clicked or not (Step S69). When it is determined at Step S69 that the rearrangement button J is not clicked, the system control circuit 10 determines whether the “cancel” button C shown in the edit screen of FIG. 8 is clicked or not (Step S70). When it is determined at Step S70 that the “cancel” button C is not clicked, the subroutine program returns to Step S69.

When it is determined at Step S69 or S60 that the “combine” (or “group”) button J is clicked, the system control circuit 10 performs Steps S71 to S74 in turn. Specifically, the system control circuit 10 retrieves the recording area information, which represents the recording areas of the programs shown in the program title frame TW on the edit screen (FIG. 8), from the recorded program information (FIG. 3) recorded in the management region of the hard disc 120 (Step S71). The system control circuit 10 then creates playback order information to sequentially play the programs in the order shown in the current program title frame TW (Step S72). The playback order information is utilized to successively track the recording areas of the programs on the hard disc so as to reproduce the programs in the decided order. Next, the system control circuit 10 prepares a new program name on the basis of the keyword entered in the keyword box KW (Step S73). When the program name “ER” is input to the keyword box KW, a new program name “ER, compiled” is prepared for instance. When the program name “news” is input to the keyword box KW, a new program name, for instance, “news, compiled” is prepared. When the person's name “MA” is input to the keyword box KW, a new program name, for instance, “MA Featuring Programs” is prepared.

The system control circuit 10 then produces edited program information from the above described new program name and the playback order information as shown in the lower half of FIG. 3, and supplies a command to the hard disc device 12 to record the edited program information in the management region of the hard disc 120 (Step S74).

When Step S74 is complete or the cancellation button C is clicked at Step S70, the system control circuit 10 exits the edit subroutine shown in FIG. 5 and returns to a main routine (not shown).

In sum, when a keyword is entered by the user, programs that match the keyword are automatically selected (retrieved) from the programs recorded on the hard disc 120 (Steps S50 to S55). When the user decides the order of joining these programs (Steps S56 to S59), the playback order information is prepared (Steps S61 to S72). A new program name is automatically attached to a group of joined programs in accordance with the keyword (Step S73). The edited program information that includes the new program name and the playback order information (FIG. 3) is written into the management region of the hard disc 120 (Step S74).

A group (series) of joined programs such as “ER (Episode 1)”, “ER (Episode 2)” and “ER (Episode 3)” can be considered as a new single program. Therefore, a new program is hypothetically created from some programs selected from those recorded on the hard disc 120.

(4) Playback

When the user wants to play a desired program among those recorded on the hard disc 120, the user firsts pushes the list button LD on the operation unit 20. The system control circuit 10 then reads the recorded program information and the edited program information (FIG. 3) from the management region of the hard disc 120, and stores them into a memory (not shown). The system control circuit 10 issues a command to the OSD image creation circuit 19 to display the list of the program names included in the recorded program information and the list of the program names included in the edited program information. Thus, the display unit 200 shows the list of the programs as shown in FIG. 9.

The user then operates the cursor button CSL on the operation unit 20 to move the selection frame SB over a name of a desired program (i.e., a program to be played), and presses the play button P on the operation unit 20. The system control circuit 10 extracts the recording area information of the program selected by the selection frame SB from the recorded program information or the playback order information of the selected program from the edited program information. The system control circuit 10 then issues a command to the hard disc apparatus 12 such that the selected program is reproduced from the recording area specified by the recording area information, or such that a plurality of programs are successively reproduced in accordance with the playback order information.

When the user selects “Friends” among the programs indicated in the recorded program list screen of FIG. 9, the system control circuit 10 retrieves the recording area information “20200” to “21700” of “Friends” (Recordation #3) from the recorded program information group shown in FIG. 3. The hard disc apparatus 12 then reproduces the information recorded in the recording area “20200” to “21700” inside the data region of the hard disc 120.

When the user selects “ER, compiled” among the programs indicated in the recorded program list screen of FIG. 9, the system control circuit 10 retrieves the playback order information (“70150” to “70650”, “21700” to “22000” and “10000” to “10500”) of the selected program (“ER, compiled”) from the edited program information group shown in FIG. 3. The hard disc apparatus 12 first reproduces the information recorded in the recording area “70150” to “70650” inside the data region of the hard disc 120. When the playback operation till “70650” is complete, then the hard disc apparatus 12 sequentially reproduces the information recorded in the next recording area “21700” to “22000”. When the playback operation till “22000” is complete, then the hard disc apparatus 12 sequentially reproduces the information recorded in the recording area “10000” to “10500”.

In this manner, when the user selects the edited program “ER, compiled”, the hard disc apparatus 12 successively plays “ER (Episode 3)” broadcast on Jan. 24, 2001, “ER (Episode 2)” broadcast on Jan. 17, 2001 and “ER (Episode 1)” broadcast on Jan. 10, 2001 in this order.

In the above described example, “ER (Episode 3)”, “ER (Episode 2)” and “ER (Episode 1)” are entirely combined so that the whole stories of “ER (Episode 3)”, “ER (Episode 2)” and “ER (Episode 1)” are played back. It is, however, possible to omit some portions of the television programs (e.g., starting and/or ending portions of the television programs) and combine the trimmed television programs. In this case, the playback order information to be stored in the edited program information group are somewhat different from that shown in FIG. 3.

Although the hard disc (magnetic recordation type) is employed as the recording medium to record the broadcast programs in the above described embodiment, the present invention is not limited in this regard. For example, an optical recordation type medium such as DVD-RW, DVD-R and DVD-RAM may be utilized as the recording medium. Alternatively, a semiconductor type recording medium may be utilized.

It should also be noted that contents to be edited are not limited to the broadcast programs. For instance, a plurality of pieces of image data, which are videoed by a user, may be joined (edited) with each other by the method described above. Alternatively, a plurality of pieces of music data may be selected and combined.

This application is based on a Japanese patent application No. 2001-29036, and the entire disclosure thereof is incorporated herein by reference.

What is claimed is:

1. An information playback apparatus for reproducing at least one piece of information from a plurality of pieces of information recorded on a recording medium comprising:
a search unit for searching pieces of information that match a search condition from the plurality of pieces of information recorded on the recording medium; and
a preparation unit for preparing playback order information to successively play the searched pieces of information in predetermined order.

2. The information playback apparatus according to claim 1 further including:
a creation unit for creating name information representing the searched pieces of information on the basis of the search condition; and
a memory for storing the name information together with the playback order information.

3. The information playback apparatus according to claim 2, wherein a plurality of name information is stored in the memory in connection with a plurality of playback order information respectively, and the information playback apparatus further includes:
a specifying unit for specifying name information among the plurality of name information stored in the memory; and
a retrieval unit for successively retrieving and playing the pieces of information, which the specified name information is associated with, from the recording medium in accordance with the playback order information of the specified name information.

4. The information playback apparatus according to claim 1, wherein the predetermined order is recording date order of the searched pieces of information.

5. The information playback apparatus according to claim 1, wherein the predetermined order is recording time order of the searched pieces of information.

6. The information playback apparatus according to claim 1 further including a determination unit for determining the predetermined order.

7. The information playback apparatus according to claim 1 further including a unit for generating an image signal to display an edit screen having a first section to enter the search condition and a second section to indicate at least one of the pieces of information recorded on the recording medium and the searched pieces of information.

8. The information playback apparatus according to claim 1, wherein each piece of information is image data representing a television program, and the search condition is at least one of a name of the television program, a genre of the television program and a personal name appearing in the television program.

9. A program playback apparatus for reproducing at least one television program from a plurality of television programs recorded on a recording medium, comprising:
a unit for generating an image signal to display an edit screen having a first section to enter a search condition and a second section to indicate a list of names of the plurality of television programs recorded on the recording medium;
a search unit for searching television programs that match the search condition from the plurality of television programs recorded on the recording medium;
a preparation unit for preparing playback order information to successively play the searched television programs in predetermined order;
a creation unit for creating name information representing the searched television programs on the basis of the search condition; and
a memory for storing the name information together with the playback order information.

10. The program playback apparatus according to claim 9, wherein a plurality of name information is stored in the memory in connection with a plurality of playback order information respectively, and the program playback apparatus further includes:
a specifying unit for specifying name information among the plurality of name information stored in the memory; and
a retrieval unit for successively retrieving and playing the television programs, which the specified name information is associated with, from the recording medium in accordance with the playback order information of the specified name information.

11. The program playback apparatus according to claim 9, wherein the playback order information includes information about recording areas of the television programs on the recording medium.

12. The program playback apparatus according to claim 9, wherein the predetermined order is recording date order of the searched television programs.

13. The program playback apparatus according to claim 9, wherein the predetermined order is recording time order of the searched television programs.

14. The program playback apparatus according to claim 9 further including a determination unit for determining the predetermined order.

15. A method of editing pieces of information selected from a plurality of pieces of information recorded on a recording medium comprising the steps of:
A) searching pieces of information that match a search condition from the plurality of pieces of information recorded on the recording medium;
B) preparing playback order information to successively play the searched pieces of information in predetermined order;
C) creating name information representing the searched pieces of information on the basis of the search condition; and
D) storing the name information together with the playback order information.

16. The method according to claim 15, wherein a plurality of name information is stored in connection with a plurality of playback order information respectively, and the method further includes the steps of:
E) specifying name information among the plurality of name information; and
F) successively retrieving and playing the pieces of information, which the specified name information is associated with, from the recording medium in accordance with the playback order information of the specified name information.

17. The method according to claim 15, wherein the predetermined order is recording date order of the searched pieces of information.

18. The method according to claim 15, wherein the predetermined order is recording time order of the searched pieces of information.

19. The method according to claim 15 further including the step of determining the predetermined order.

20. The method according to claim 15 further including the step of generating an image signal to display an edit screen having a first section to enter the search condition and a second section to indicate at least one of the pieces of information recorded on the recording medium and the searched pieces of information.

21. The method according to claim 15, wherein each piece of information is image data representing a television program, and the search condition is at least one of a name of the television program, a genre of the television program and a personal name appearing in the television program.

22. A method of editing television programs selected from a plurality of television programs recorded from a recording medium, comprising the steps of:
A) generating an image signal to display an edit screen having a first section to enter a search condition and a second section to indicate a list of names of the plurality of television programs recorded on the recording medium;
B) searching television programs that match the search condition from the plurality of television programs recorded on the recording medium;
C) preparing playback order information to successively play the searched television programs in predetermined order;
D) creating name information representing the searched television programs on the basis of the search condition; and
E) storing the name information together with the playback order information.

23. The method according to claim 22, wherein a plurality of name information is stored in connection with a plurality of playback order information respectively, and the method further includes:
F) specifying name information among the plurality of name information stored in the memory; and
G) successively retrieving and playing the television programs, which the specified name information is associated with, from the recording medium in accordance with the playback order information of the specified name information.

24. The method according to claim 22, wherein the playback order information includes information about recording areas of the television programs on the recording medium.

25. The method according to claim 22, wherein the predetermined order is recording date order of the searched television programs.

26. The method according to claim 22, wherein the predetermined order is recording time order of the searched television programs.

27. The method according to claim 22 further including the step of determining the predetermined order.

28. A computer data signal embodied in a carrier wave and representing a series of instructions which cause a computer to perform steps to execute an editing process in an editing apparatus, said steps comprising:
searching pieces of information that match a search condition from a plurality of pieces of information recorded on a recording medium;
preparing playback order information to successively play the searched pieces of information in predetermined order;
creating name information representing the searched pieces of information on the basis of the search condition; and
storing the name information together with the playback order information.

29. The computer data signal according to claim 28, wherein the predetermined order is recording date order of the searched pieces of information.

30. The computer data signal according to claim 28, wherein the predetermined order is recording time order of the searched pieces of information.

31. The computer data signal according to claim 28 further including the step of determining the predetermined order.

32. The computer data signal according to claim 28 further including the step of generating an image signal to display an edit screen having a first section to enter the search condition and a second section to indicate at least one of the pieces of information recorded on the recording medium and the searched pieces of information.

33. The computer data signal according to claim 28, wherein each piece of information is image data representing a television program, and the search condition is at least one of a name of the television program, a genre of the television program and a personal name appearing in the television program.

34. A computer data signal embodied in a carrier wave and representing a series of instructions which cause a computer to perform steps to execute an editing process in an editing apparatus, said steps comprising:
generating an image signal to display an edit screen having a first section to enter a search condition and a second section to indicate a list of names of a plurality of television programs recorded on a recording medium;
searching television programs that match the search condition from the plurality of television programs recorded on the recording medium;
preparing playback order information to successively play the group of television programs in predetermined order;
creating name information representing the searched television programs on the basis of the search condition; and
storing the name information together with the playback order information.

35. The computer data signal according to claim 34, wherein the playback order information includes information about recording areas of the television programs on the recording medium.

36. The computer data signal according to claim 34, wherein the predetermined order is recording date order of the searched television programs.

37. The computer data signal according to claim 34, wherein the predetermined order is recording time order of the searched television programs.

38. The computer data signal according to claim 34 further including the step of determining the predetermined order.
